(19) United States
(12) Patent Application Publication
(10) Pub. No.: US 2015/0109884 A1
(43) Pub. Date: Apr. 23, 2015

(54) DIPOLE SEISMIC SOURCE AND METHOD FOR ADJUSTING RADIATION PATTERN

(71) Applicant: CGG SERVICES SA, Massy Cedex (FR)

(72) Inventors: Julien COTTON, Paris (FR); Eric FORGUES, Bures-sur-Yvette (FR); Francois-Xavier GRESILLON, Rully (FR)

(73) Assignee: CGG SERVICES SA, Massy Cedex (FR)

(21) Appl. No.: 14/246,241

(22) Filed: Apr. 7, 2014

Related U.S. Application Data
(60) Provisional application No. 61/893,458, filed on Oct. 21, 2013.

(51) Int. Cl. G01V 1/04

(52) U.S. Cl. CPC G01V 1/04; G01V 1/40
USPC 367/25

(57) ABSTRACT

A seismic survey system for surveying a subsurface. The system includes a dipole seismic source buried in a well and configured to generate P-waves having a first radiation pattern and to generate S-waves having a second radiation pattern; plural seismic sensors distributed about the dipole seismic source and configured to record seismic signals corresponding to the P- and S-waves; and a controller connected to the dipole seismic source and configured to drive it. A longitudinal axis of the dipole seismic source is inclined with an inclination angle (θ) relative to gravity.

### BACKGROUND

1. Technical Field

Embodiments of the subject matter disclosed herein generally relate to devices and methods for generating seismic waves and, more particularly, to mechanisms and techniques for generating seismic waves having desired radiation pattern orientations.

2. Discussion of the Background

Seismic sources may be used to generate seismic waves in underground formations for investigating geological structures. A land seismic source may be located on the ground or it may be buried in the ground. The seismic source, when activated, imparts energy into the ground. Part of that energy travels downward and interacts with the various underground layers. At each interface between these layers, part of the energy is reflected and part of the energy is transmitted to deeper layers. The reflected energy travels toward the surface of the earth, where it is recorded by seismic sensors. Based on the recorded seismic data (traces), images of the underground layers may be generated. Those skilled in the art of seismic image interpretation are then able to estimate whether oil and/or gas reservoirs are present underground. A seismic survey investigating underground structures may be performed on land or water.

Current land seismic sources generate a mixture of P-waves and S-waves. A P-wave (or primary wave or longitudinal wave) is a wave that propagates through the medium using a compression mechanism, i.e., a particle of the medium moves parallel to a propagation direction of the wave and transmits its movement to a next particle of the medium. This mechanism is capable of transmitting energy both in a solid medium (e.g., earth) and in a fluid medium (e.g., water). An S-wave, different from a P-wave, propagates through the medium using a shearing mechanism, i.e., a particle of the medium moves perpendicular to the propagation direction of the wave and shears the medium. This particle makes the neighboring particle also move perpendicular to the wave's propagation direction. This mechanism is incapable of transmitting energy in a fluid medium, such as water, because there is not a strong bond between neighboring water particles. Thus, S-waves propagate only in a solid medium, i.e., earth.

The two kinds of waves propagate with different speeds, with P-waves being faster than S-waves. Also, the two kinds of waves are generated with different radiation patterns by a same seismic source. The P- and S-waves may carry different information regarding the subsurface and, thus, both types of waves are useful for generating a subsurface image. However, when both of them are generated with a single seismic source, one type of waves has weaker energy content along a desired direction than the other type. This problem of the conventional land sources is illustrated in FIG. 1.

FIG. 1 illustrates a radiation pattern 100 generated by a dipole vibrating seismic source. A dipole vibrating seismic source generates energy by, for example, moving two parts in opposite direction while underground. Note that a dipole vibrating seismic source generates P-waves having the pattern illustrated by curves 102 and S-waves having the pattern illustrated by curves 104. FIG. 1 shows that P-waves' maximum energy is generated on the vertical axis Z, while the S-waves' maximum energy is emitted on oblique lines 106 that make a 45° angle with the vertical axis. FIG. 1 also shows that the energy ratio between the S- and P-waves favors the S-waves (their lobes are larger than those of the P-waves).

A seismic source 200 capable of generating radiation pattern 100 is conventionally buried within a dedicated vertical borehole 202 as illustrated in FIG. 2. Cement or other appropriate materials 204 are poured over the seismic source to improve the coupling of the seismic source with its environment. The seismic source may communicate with a control device 206 placed on the earth's surface 208 and also with a power source 209. The control device is configured to drive seismic source 200. By burying the seismic source 200 in a vertical position as illustrated in FIG. 2, the P-waves' maximum energy is generated on the vertical axis Z and the S-waves' maximum energy is emitted on the oblique axes 210, at 45° relative to vertical axis Z. Because the maximum energy of P-waves 312 is emitted vertically (as illustrated in FIG. 3), these waves can propagate deep into the earth (layers 314, 316, etc.), providing valuable information when recorded at seismic sensors 330 and/or 332 about the subsoil and possible reservoirs 318 (seismic imaging, monitoring). Contrary to the P-waves 312, the S-waves' 320 maximum energy is emitted at 45°, so these waves are refracted because of their critical angle of incidence Ic, as illustrated in FIG. 3. Refracted waves 322 also propagate toward seismic sensors 330 and 332, where they are recorded.

Because of the original emission angle of about 45°, S-waves 320 do not propagate deeply into the earth, do not reach reservoir 318 and cannot be used to extract information about earth subsoil (seismic imaging, reservoir monitoring). Note that the seismic receivers may be distributed on the ground, below the ground, or in a mixed arrangement.

From the above discussion, it is apparent there is a need to direct not only P-waves' maximum energy but also S-waves' maximum energy as closely as possible to the vertical direction for better earth penetration and for increasing the amount of data related to the surveyed area.

### BRIEF SUMMARY OF THE INVENTION

According to an embodiment, there is a seismic survey system for surveying a subsurface. The system includes a dipole seismic source buried in a well and configured to generate P-waves having a first radiation pattern and to generate S-waves having a second radiation pattern; plural seismic sensors distributed about the dipole seismic source and configured to record seismic signals corresponding to the P- and S-waves; and a controller connected to the dipole seismic source and configured to drive it. A longitudinal axis of the dipole seismic source is inclined with an inclination angle (θ) relative to gravity.

According to another embodiment, there is a seismic survey system for surveying a subsurface. The system includes a dipole seismic source buried in a well and configured to generate P-waves having a first radiation pattern and to generate S-waves having a second radiation pattern. The dipole seismic source is inclined with an inclination angle (θ) relative to gravity.

According to yet another embodiment, there is a method for generating seismic waves. The method includes placing a dipole seismic source in a well at an inclination angle (θ); and simultaneously generating P-waves having a first radiation and S-waves having a second radiation pattern, wherein the maximum energy of the first radiation pattern makes a radiation angle (σ) with the maximum energy of the second radiation pattern. The inclination angle (θ) is calculated to be equal or less than the radiation angle (σ) so that the maximum energy of the S-waves is emitted substantially along the gravity.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a radiation pattern for a dipole seismic source;

FIG. 2 is a schematic diagram of a seismic source placed in a vertical well;

FIG. 3 is a schematic diagram of S-waves generated by a seismic source placed in a vertical well;

FIG. 4A is a schematic diagram of a dipole seismic source placed in a well having an inclination angle;

FIG. 4B is a schematic diagram of a dipole seismic source placed in a well having a different inclination angle;

FIG. 4C is a schematic diagram of dipole seismic sources placed in one inclined well and one vertical well;

FIG. 5 is a schematic diagram of a radiation pattern of a dipole seismic source placed in an inclined well;

FIG. 6 is a schematic diagram of an inclined well having plural seismic sources;

FIG. 7 is a schematic diagram of plural inclined wells having plural seismic sources;

FIGS. 8 and 9 are schematic diagrams of plural inclined wells having different azimuth angles;

FIG. 10 is a schematic diagram of a dipole seismic source;

FIG. 11 is a schematic diagram of a radiation pattern associated with a dipole seismic source; and

FIG. 12 is a flowchart of a method for generating seismic waves.

### DETAILED DESCRIPTION OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a land seismic source used to perform a seismic survey to evaluate the structure of a subsurface formation. However, the embodiments are not limited to a land seismic source or seismic survey, but they may be used with other sources that are capable of simultaneously generating waves having different radiation patterns. The term seismic survey is used in this document to include any operation related to seismic data collection, e.g., 2-dimensional (2D), 3D, 4D surveying and/or reservoir monitoring.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, at least one seismic source is configured to simultaneously generate P- and S-waves with different radiation patterns, and the seismic source is inclined relative to the vertical. In another embodiment, plural seismic sources are located underground, in one or more emitting positions, so that one source emits P-waves substantially along a vertical direction and another source emits S-waves substantially along the vertical direction. In still another embodiment, a single source is located underground and oriented so both the P- and S-waves are emitted so that corresponding maximum energies make an angle with the vertical. In one application, the seismic source is placed in a well that is at a given angle with the vertical. In still another application, multiple wells are drilled at different inclinations and/or in different directions, and the seismic sources are placed in these wells.

There are some advantages in a dipole seismic source or sources having an orientation different from the vertical. Such a seismic source generates S-waves in addition to P-waves, and the S-waves' energy is higher than the P-waves'. Thus, by aligning the S-waves' radiation pattern so the maximum energy is along or close to the vertical axis, improvement in the signal-to-noise ratio is obtained. S-waves are also very sensitive to phase changing, and this property is useful in seismic monitoring, e.g., for detecting melting of heavy oil, steam chamber condensation, etc.

In addition, combined with P-waves, S-waves provide additional information about earth's properties, e.g., it facilitates reservoir inversion. Combining inclined and vertical dipole seismic sources takes advantage of the fact that both P- and S-waves propagate deeply into the earth, giving valuable information about the subsurface. Another advantage of inclining the seismic source is from an operational point of view. By locating multiple depth sources in one well, better seismic subsurface illumination is generated. If several inclined wells are combined in one or more directions and dipole vibrating seismic sources are located inside these wells, better three-dimensional acquisition may be achieved.

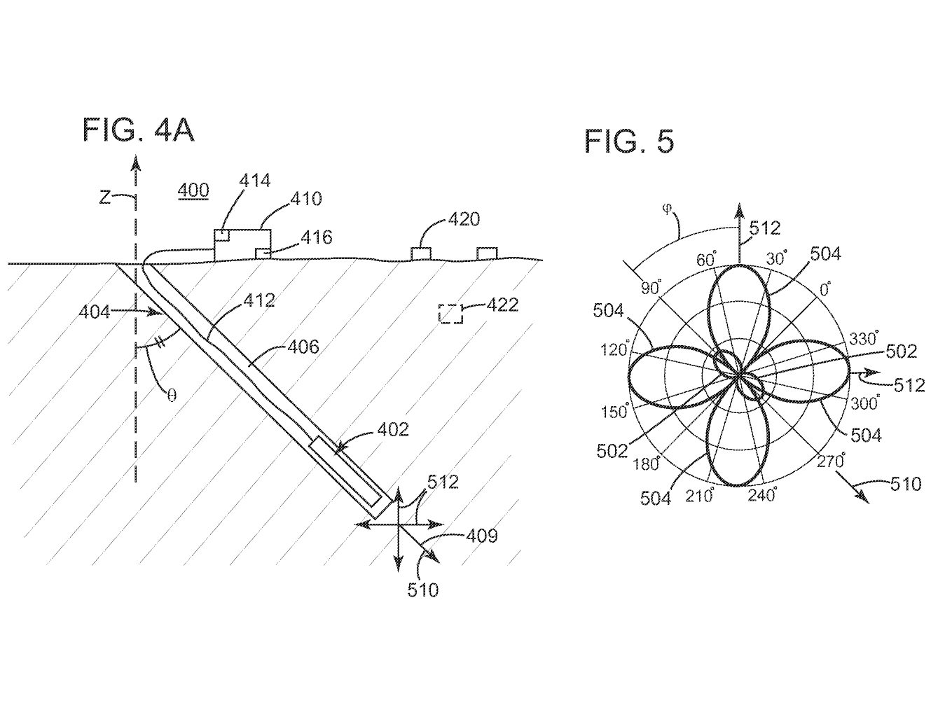

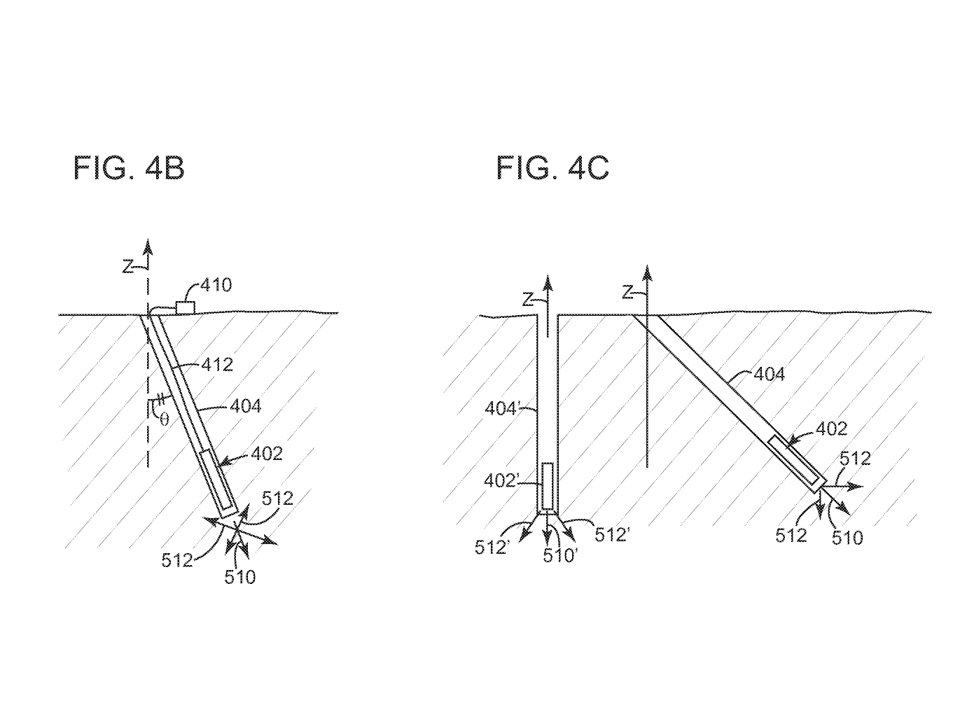

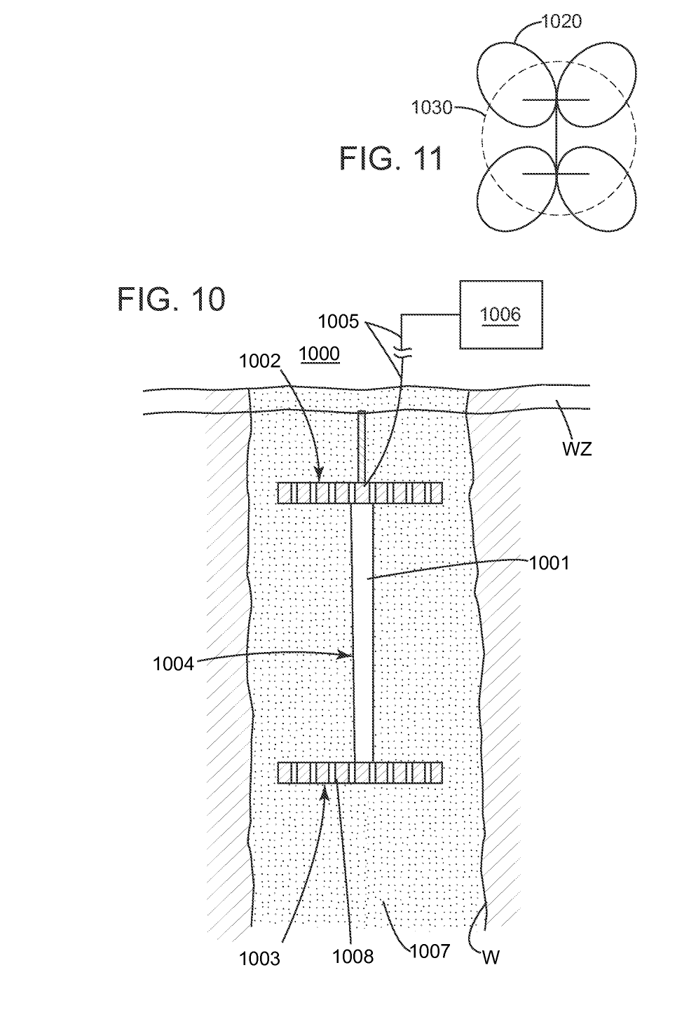

According to an embodiment illustrated in FIG. 4A, a seismic survey system 400 includes a dipole seismic source 402 placed in an inclined well 404 to change an orientation of the S-waves' radiation pattern. Dipole seismic source 402 may be any source capable of generating both P- and S-waves having different radiation patterns. A few such sources are illustrated in U.S. patent application Ser. No. 14/103,177, assigned to the assignee of this application, the entire content of which is incorporated herein by reference, and one example of a dipole seismic source is illustrated in FIG. 10. Dipole seismic source 402 may have an energy pattern as illustrated in FIG. 5. Note that a common characteristic of dipole energy sources is asymmetry between the radiation patterns of the P- and S-waves. In other words, P-waves radiation patterns 502 have a different orientation of the maximum energy than the S-waves radiation patterns 504. For simplicity, in the following, this difference is called the orientation of the maximum energy. According to this language, the maximum energy for the P-waves lies along axis 510 in FIGS. 5 and 409 in FIG. 4A, and the maximum energy for the S-waves lies along axes 512 in FIGS. 4A and 5. In other words, the maximum energy for the P-waves makes a radiation angle σ with the maximum energy for the S-waves, as illustrated in FIG. 5.

FIG. 4A also shows a control device 410 connected through a wire 412 to dipole seismic source 402. Control device 410 may include a processor 414 connected to a memory 416. An input/output interface (not shown) on the control device facilitates transfer of information between the control device and the source's user. For example, a drive signal can be stored in memory 416, and processor 414 drives source 402 based on the drive signal. The drive signal may be any type of signal used for driving a seismic source, e.g., sweep, random, pseudo-random, etc. FIG. 4A also shows plural sensors 420 located on the surface and/or sensors 422 buried underground. In one application, sensors 422 are buried above source 402. In another application, sensors 422 are buried above and below source 402. In still another application, sensors 422 are buried below source 402.

Note that an inclination angle θ between well's axis 409 and the vertical Z is about 45° in this embodiment. The well's inclination angle is chosen to have this value (i.e., the value of the radiation angle σ) so that the S-waves' maximum energy is oriented vertically, as illustrated in FIGS. 4A and 5, to take full advantage of the S-waves. In other words, the S-waves are emitted so that their maximum energy is emitted along the vertical axis and, thus, the S-waves are not refracted at the various interfaces below the source, and they propagate deeply into the earth to reach a target geological horizon. However, as also illustrated in FIGS. 4A and 5, the P-waves' maximum energy is oriented at about 45° relative to gravity, which may not be optimal. Note that the angle of about 45° made by the maximum energy of the P-waves' radiation pattern with the maximum energy of the S-waves' radiation pattern (i.e., the radiation angle σ) is in this embodiment the angle at which the source should be inclined, i.e., it is the inclination angle θ at which the well or a portion of the well should be drilled. In other words, the inclination angle of the well is related to the radiation angle. The two angles do not have to be identical, as in the FIG. 4A embodiment. In one embodiment, the inclination angle θ may be substantially half the radiation angle σ so that both P- and S-waves are emitted to avoid the refraction noted in FIG. 3. FIG. 4B shows such an embodiment, in which the inclination angle is about 22° while the radiation angle σ is about 45°. FIG. 4C illustrates another embodiment having a configuration in which an inclined well 404 is used together with a vertical well 404′ having a corresponding source 402′ such that P-waves' maximum energy is emitted along gravity by source 402′ and S-waves' maximum energy is emitted along gravity by source 402. Those skilled in the art will recognize that other inclination angles or combinations of inclination angles may be used, and they may change as a function of the radiation angle.

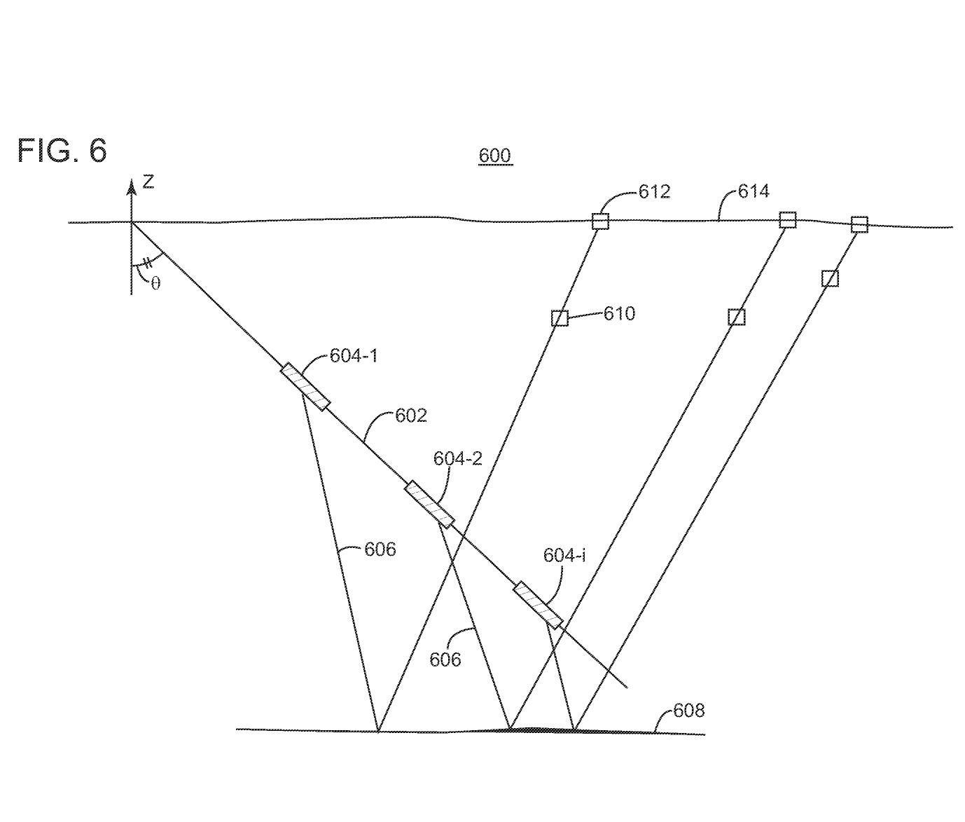

In one embodiment as illustrated in FIG. 6, an acquisition seismic system 600 includes a well 602 making a predetermined angle (or inclination angle) θ with a vertical axis Z. FIG. 6 shows well 602 being a straight line. In one application, well 602 may have multiple portions, some of them straight lines, with the same or different inclination angles. For example, well 602 may have an “s” shape, i.e., curved portions and straight line portions with different inclination angles. Those skilled in the art would recognize that well 602 may take many shapes to accommodate plural dipole seismic sources having different inclinations. In one application, a depth of the well is larger than 5 m. In one example, the well has a depth between 100 and 250 m. Other depths are possible.

Well 602 may accommodate plural dipole seismic sources 604-i, where “i” is between 2 and 100. Waves 606 generated by the dipole seismic sources 604-i are reflected off various subsurface features 608 and are recorded by seismic sensors 610 and/or 612. Seismic sensors 610 are buried underground while seismic sensors 612 are at ground level 614. The seismic sensors' 610 depth may vary from sensor to sensor according to a given scheme or mathematical curve. In one embodiment, both sets of sensors 610 and 612 are used. Seismic sensors 610 and/or 612 may include any known sensor, e.g., a geophone, hydrophone, accelerometer, optical sensor, a combination of them, etc. In one application, the seismic sensors are three-component (3C) sensors, i.e., sensors capable of measuring a particle motion vector (e.g., speed or displacement).

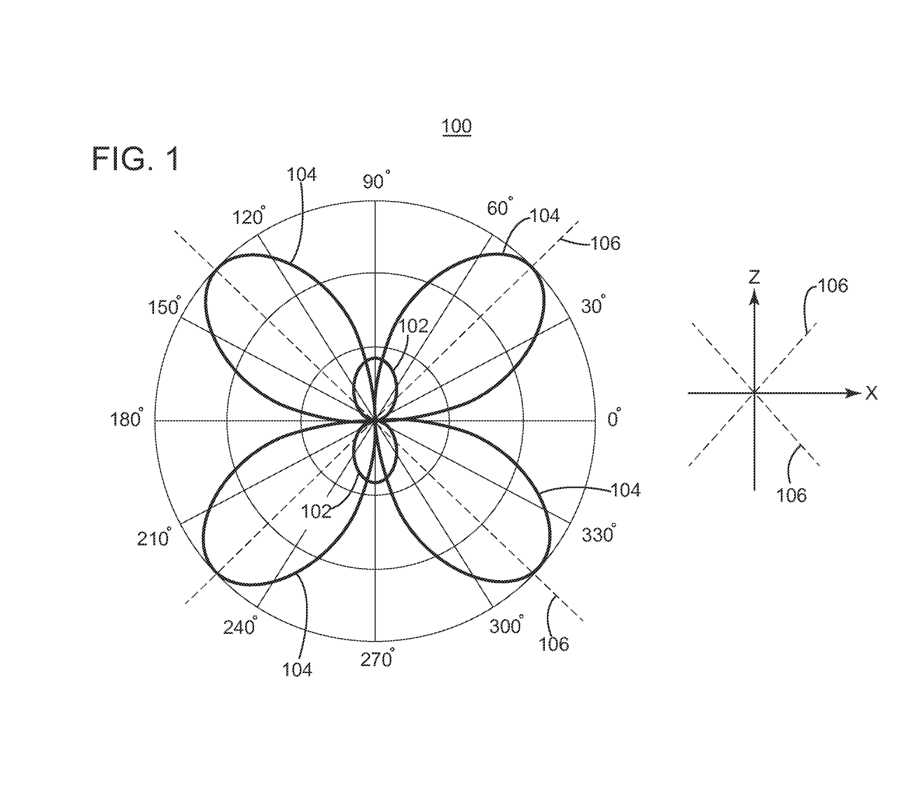

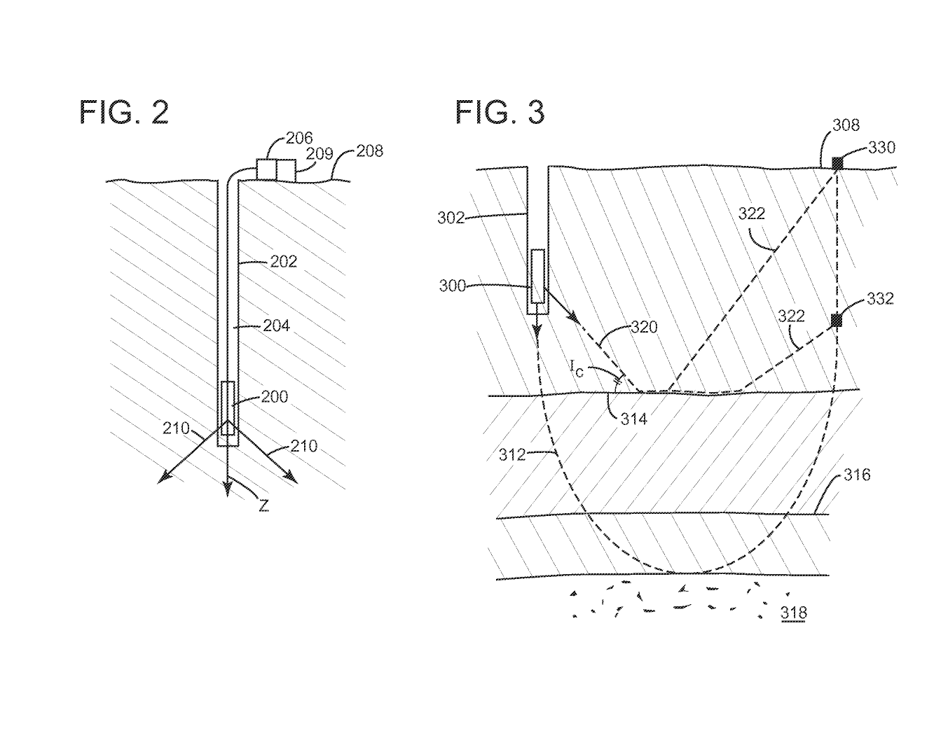

The inclination angle of the well depends on the needs of each survey and also upon the type of dipole seismic source. For example, if the dipole seismic source has a different radiation pattern from that shown in FIGS. 1 and 5, for example, one in which the P-waves have their maximum energy vertically oriented and the S-waves have their maximum energy oriented at 25° relative to the vertical, then the inclination angle θ may be about 25° for emitting the S-waves' maximum energy along gravity. In other words, there is a direct correlation between the inclination angle and the seismic source's radiation angle so that maximum energy of either P-waves or S-waves is substantially oriented along the vertical.

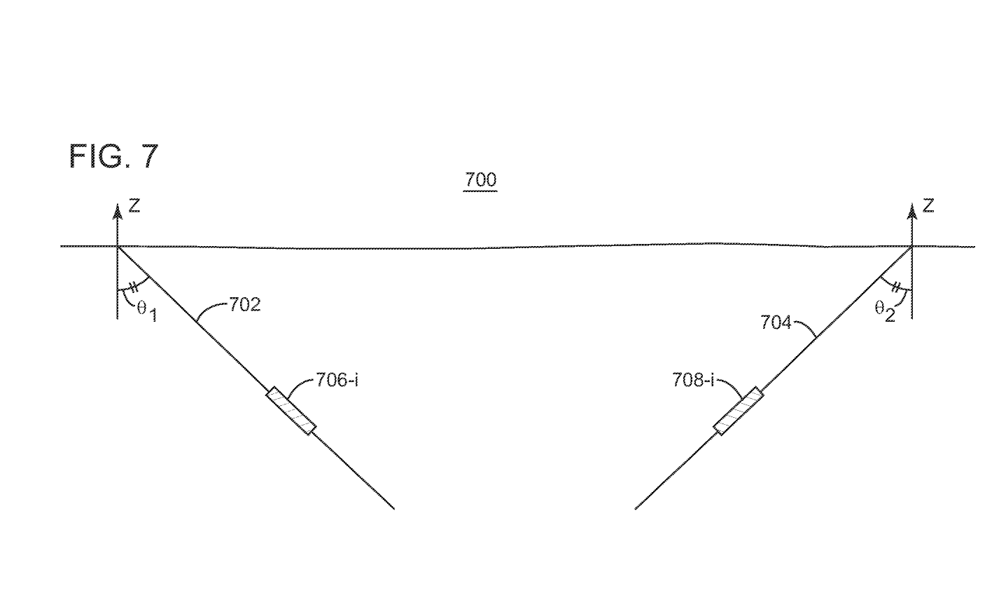

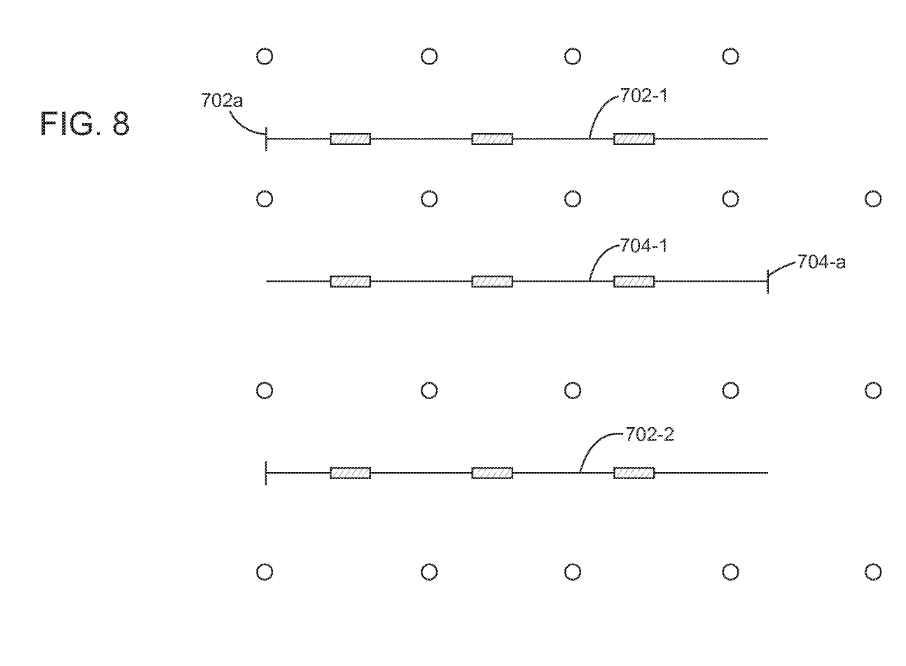

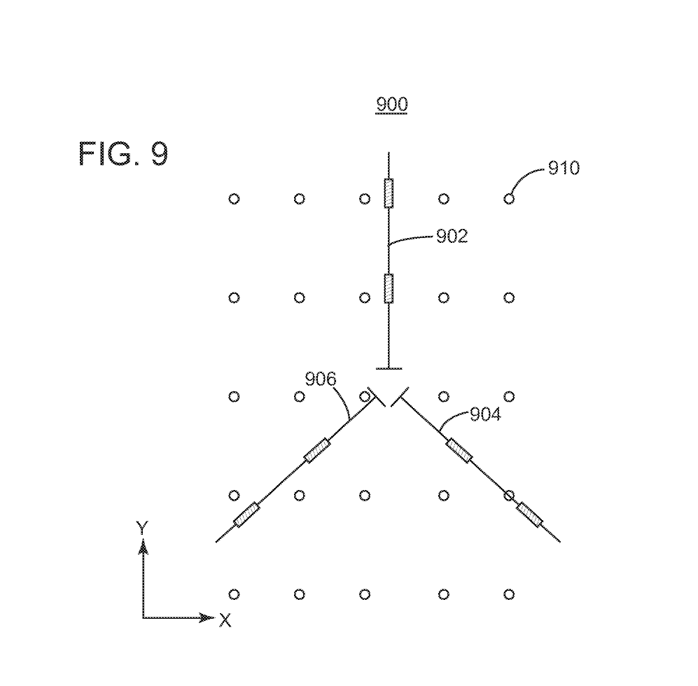

In one embodiment, to obtain a better source illumination, more than one well is drilled in the area of interest. As illustrated in FIG. 7, in one application, a seismic acquisition system 700 includes plural wells 702 and 704 drilled with corresponding inclination angles θ₁ and θ₂. The inclination angles may be the same for all the wells or may be well-specific (i.e., two wells may have different inclination angles). In one embodiment, one well has a substantially zero inclination angle to maximize the P-waves' energy, and another well has a substantially 45° inclination angle to maximize the S-waves' energy if the source has a radiation pattern as illustrated in FIG. 5. Each well 702 and 704 may include one or more dipole source elements 706-i or 708-i, respectively. Other sources may also be placed inside the wells. In one application, the number of wells is between two and 20. A larger number of wells may also be used. The arrangement illustrated in FIG. 7 may have the wells alternately inclined, as illustrated in FIG. 8, which shows the heads 702a and 704a of wells 702-1 and 704-1, respectively, alternatively arranged, i.e., having the same inclination angle but different azimuth angles relative to gravity. In one application, the azimuth angles are zero and 180, as illustrated in FIG. 8. Other arrangements are also possible, for example, a star arrangement as illustrated in FIG. 9. System 900 illustrated in FIG. 9 includes at least three wells 902, 904 and 906 distributed 120° from each other (i.e., azimuth angles of 0°, 120° and 240°) when projected on the horizontal X-Y plane. The wells' inclination may be about 45° relative to the vertical, as noted above.

The wells noted above may be drilled on land, seabed, river, etc. There is no limitation with regard to the wells' length, e.g., between 1 and 10,000 m, the wells' inclinations, size, number, nor the number of dipole seismic sources located in the wells. There is also no limitation with regard to the type of dipole seismic source. For example, in one embodiment, one source generates mainly S-waves and another source generates mainly P-waves. As long as the seismic sources generate radiation patterns including S- and P-waves, these sources may be combined as discussed above to generate seismic waves that maximize the P- and/or S-energy. In one embodiment, dipole seismic sources may be mixed with non-dipole sources during the seismic survey.

An example of a dipole seismic source is now discussed with regard to FIG. 10, which illustrates source 1000 (a similar source is described, for example, in U.S. Pat. No. 7,420,879 to Meynier et al., the entire content of which is incorporated herein by reference) that includes plural vibrators (electromechanical, electromagnetic, hydraulic, piezoelectric, magnetostrictive, etc.) forming a pillar 1001 in contact with plates 1002 and 1003. Alternatively or in addition, the source can be a buried reactive mass source that has a constrained mass on top of either plate 1002 and/or 1003. A force is applied to pillar 1001 to displace plates 1002 and 1003, thereby generating seismic waves. Because the ground around the source is displaced asymmetrically, strong S-waves are generated. FIG. 11 schematically illustrates lobes 1020 representing the S-waves and waves 1030 representing P-waves.

Pillar 1001, which may be covered with a deformable membrane 1004, is connected by a cable 1005 to a signal generator 1006. Source 1000 is placed in a cavity or well W, for example, of 5 to 30 cm in diameter, at a desired depth under the weather zone layer WZ, for example, at a depth greater than 3 m. A coupling material 1007, such as cement or concrete, is injected into the well to be in direct contact with pillar 1001 over the total length thereof and with plates 1002 and 1003. To allow the coupling material 1007 to be homogeneously distributed in the space between plates 1002 and 1003, the plates may have perforations 1008. The diameter of plates 1002 and 1003 substantially corresponds to the diameter of the cavity or well W so as to achieve maximum coupling surface area.

The signal generator 1006 generates an excitation signal in a frequency sweep or a single frequency, causing elements forming pillar 1001 to expand or contract temporarily along the pillar's longitudinal axis. Metal plates 1002 and 1003 are mounted on the pillar ends to improve the coupling of pillar 1001 with coupling material 1007. Coupling material 1007 intermediates the coupling between the source and the formation. For example, plates 1002 and 1003 have a thickness of about 10 cm and a diameter of about 10 cm. Pillar 1001 may have a length exceeding 80 cm. Membrane 1004 may be made of polyurethane and surround pillar 1001 to decouple it from the coupling material (cement) 1007. Thus, only the end portions of pillar 1001 and plates 1002 and 1003 are coupled with the coupling material (cement) 1007. Upon receiving an excitation (electrical signal) from the signal generator 1006, source 1000 generates forces along the pillar's longitudinal axis. This conventional source provides good repeatability and high reliability, once a good coupling is accomplished. Note that the above numbers are exemplary.

A typical pillar may have a cylindrical shape with a radius of 5 cm and a length of 95 cm. This pillar may consist of 120 ceramics made, for example, of lead-zirconate-titanate (PZT) known under the commercial name NAVY type I. Each ceramic may have a ring shape with 20 mm internal diameter, 40 mm external diameter and 4 mm thickness. The maximum length expansion obtainable for this pillar in the absence of constraints is 120 μm, corresponding to a volume change of about 1000 mm³. The numbers presented above are exemplary and those skilled in the art would recognize that various sources have different characteristics. Other non-volumetric sources exist but are not presented herein.

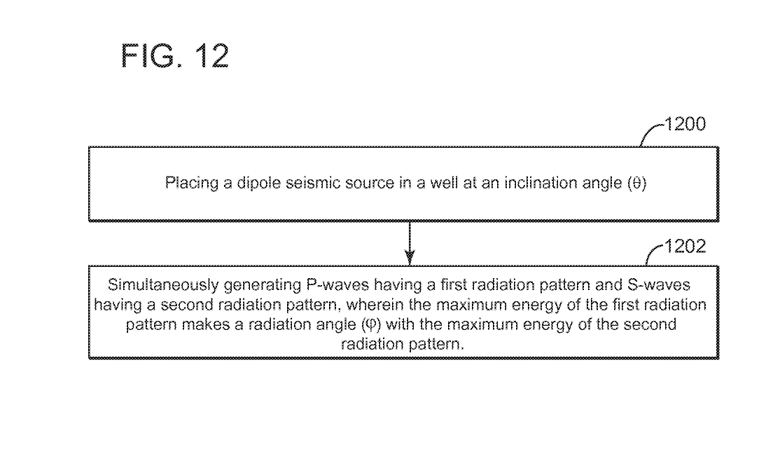

A method for generating seismic waves is illustrated in FIG. 12, which includes a step 1200 of placing a dipole seismic source in a well at an inclination angle (θ) and a step 1202 of simultaneously generating P-waves having a first radiation pattern and S-waves having a second radiation pattern, wherein the maximum energy of the first radiation pattern makes a radiation angle (σ) with the maximum energy of the second radiation pattern. The inclination angle (θ) is calculated to be equal or less than the radiation angle (σ) so that the maximum energy of the S-waves is emitted substantially along gravity.

The disclosed exemplary embodiments provide seismic acquisition systems that orient a radiation pattern of a dipole seismic source with a desired direction for obtaining maximum information from the generated S-waves. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A seismic survey system for surveying a subsurface, the system comprising:
a dipole seismic source buried in a well and configured to generate P-waves having a first radiation pattern and to generate S-waves having a second radiation pattern;
plural seismic sensors distributed about the dipole seismic source and configured to record seismic signals corresponding to the P- and S-waves; and
a controller connected to the dipole seismic source and configured to drive it,
wherein a longitudinal axis of the dipole seismic source is inclined with an inclination angle (θ) relative to gravity.

2. The system of claim 1, wherein the maximum energy of the first radiation pattern makes a radiation angle (σ) with the maximum energy of the second radiation pattern and the inclination angle (θ) is substantially equal to the radiation angle (σ).

3. The system of claim 2, wherein the well is drilled at the inclination angle.

4. The system of claim 2, wherein the well has multiple portions with one portion drilled at the inclination angle and one portion drilled vertically.

5. The system of claim 2, wherein the well has multiple portions with one portion drilled at the inclination angle and one portion drilled at another inclination angle.

6. The system of claim 1, wherein the maximum energy of the first radiation pattern makes a radiation angle (σ) with the maximum energy of the second radiation pattern and the inclination angle (θ) is less than the radiation angle (σ).

7. The system of claim 1, further comprising:
another dipole seismic source located in another well.

8. The system of claim 7, wherein the another dipole seismic source has another inclination than the dipole seismic source.

9. The system of claim 7, wherein the another well has another inclination than the well.

10. The system of claim 7, wherein a portion of the well is inclined at substantially 45° and the another well is substantially aligned with gravity.

11. The system of claim 10, wherein the dipole seismic source emits the S-waves so that their maximum energy is aligned with the gravity and the another dipole seismic source emits the P-waves so that their maximum energy is aligned with the gravity.

12. The system of claim 7, wherein the well and the another well have the same inclination angle but different azimuth angles relative to the gravity.

13. The system of claim 12, wherein the azimuth angles are substantially 0 and 180.

14. The system of claim 12, wherein the azimuth angles are substantially 0, 120 and 240.

15. A seismic survey system for surveying a subsurface, the system comprising:
a dipole seismic source buried in a well and configured to generate P-waves having a first radiation pattern and to generate S-waves having a second radiation pattern,
wherein the dipole seismic source is inclined with an inclination angle (θ) relative to gravity.

16. The system of claim 15, wherein the maximum energy of the first radiation pattern makes a radiation angle (σ) with the maximum energy of the second radiation pattern and the inclination angle (θ) is substantially equal to the radiation angle (σ).

17. The system of claim 15, wherein the maximum energy of the first radiation pattern makes a radiation angle (σ) with the maximum energy of the second radiation pattern and the inclination angle (θ) is less than the radiation angle (σ).

18. The system of claim 15, further comprising:
another dipole seismic source located in another well, wherein a portion of the well is inclined at substantially 45° and the another well is substantially aligned with gravity.

19. The system of claim 18, wherein the dipole seismic source emits the S-waves so that their maximum energy is aligned with the gravity and the another dipole seismic source emits the P-waves so that their maximum energy is aligned with the gravity.

20. A method for generating seismic waves, the method comprising:
placing a dipole seismic source in a well at an inclination angle (θ); and
simultaneously generating P-waves having a first radiation and S-waves having a second radiation pattern, wherein the maximum energy of the first radiation pattern makes a radiation angle (σ) with the maximum energy of the second radiation pattern,
wherein the inclination angle (θ) is calculated to be equal or less than the radiation angle (σ) so that the maximum energy of the S-waves is emitted substantially along the gravity.
